(19) United States
(12) Patent Application Publication
(10) Pub. No.: US 2012/0308065 A1
(43) Pub. Date: Dec. 6, 2012

(54) SOUND BAR

(75) Inventors: Ernie PADALINO, Rutherford, NJ (US); Koshiro HASHIMOTO, Rutherford, NJ (US)

(73) Assignees: FUNAI ELECTRIC CO., LTD., Osaka (JP); FUNAI CORPORATION INC., Rutherford, NJ (US)

(21) Appl. No.: 13/151,562

(22) Filed: Jun. 2, 2011

(51) Int. Cl. H04R 1/02

(52) U.S. Cl. 381/335

(57) ABSTRACT

A sound bar includes a housing, a rotary member, first and second speaker boxes, and a gear mechanism. The rotary member is rotatable with respect to the housing. The first and second speaker boxes are slidable with respect to the housing, respectively. The first and second speaker boxes are disposed at opposite end portions of the housing in a lengthwise direction of the housing, respectively. The gear mechanism is disposed between the rotary member and the first and second speaker boxes. The gear mechanism is configured to slide both the first and second speaker boxes with respect to the housing in opposite directions of the housing along the lengthwise direction of the housing in response to a rotational movement of the rotary member.

### BACKGROUND

1. Field of the Invention

The present invention generally relates to a sound bar. More specifically, the present invention relates to an expandable sound bar.

2. Background Information

Recently, the need for a sound bar system has been emerging since users want to enjoy a full surround sound experience without a hassle. Currently, users enjoy high quality video with a flat panel TV or such display device. However, the built-in speakers of the flat panel TV normally do not deliver proper sound that matches the high quality video. One option to solve the problem is to install a surround sound system, such as 5.1 system, 7.1 system and the like. However, installation of such surround sound system is quite a hassle since, for example, 5.1 system requires making room for five speakers and a subwoofer, connecting cables to each speaker, and adjusting directions of the speakers.

The sound bar system has been developed for the users who want to enjoy the full surround sound experience without such hassle. The sound bar system offers the surround sound with a single piece of sound bar and an optional subwoofer. The sound bar is much wider than it is tall. The sound bar is normally disposed above or below the flat panel TV or hanged on the wall, and is simply connected to the flat panel TV with a cable.

### SUMMARY

It has been discovered that it is preferable for the length of the sound bar to match the size of the flat panel TV for acoustic and aesthetic reasons. Specifically, with the conventional sound bar, the length of the sound bar can not be easily adjusted. Thus, upon purchasing a sound bar, the user needs to find a sound bar having a proper length that matches the width of the flat panel TV.

The present invention was conceived in light of the above-mentioned problems. One object of the present invention is to provide a sound bar whose length is easily adjustable.

In accordance with one aspect, a sound bar includes a housing, a rotary member, first and second speaker boxes, and a gear mechanism. The rotary member is rotatable with respect to the housing. The first and second speaker boxes are slidable with respect to the housing, respectively. The first and second speaker boxes are disposed at opposite end portions of the housing in a lengthwise direction of the housing, respectively. The gear mechanism is disposed between the rotary member and the first and second speaker boxes. The gear mechanism is configured to slide both the first and second speaker boxes with respect to the housing in opposite directions of the housing along the lengthwise direction of the housing in response to a rotational movement of the rotary member.

With the sound bar, it is possible to provide a sound bar whose length is easily adjustable.

These and other objects, features, aspects and advantages will become apparent to those skilled in the art from the following detailed description, which, taken in conjunction with the annexed drawings, discloses a preferred embodiment.

### BRIEF DESCRIPTION OF THE DRAWINGS

Referring now to the attached drawings which form a part of this original disclosure:

FIG. 1 is a front elevational view of a home theater system having a flat panel TV and a sound bar in accordance with one embodiment;

FIG. 2 is a rear perspective view of the sound bar illustrated in FIG. 1;

FIG. 3 is a rear perspective view of the sound bar illustrated in FIG. 1 without illustrating a front cover of the sound bar;

FIG. 4 is an exploded rear perspective view of the sound bar illustrated in FIG. 1;

FIG. 5 is an exploded front perspective view of the sound bar illustrated in FIG. 1 without illustrating the front cover and sound boxes of the sound bar;

FIG. 6 is a front elevational view of the sound bar with a partial skeleton view illustrating an arrangement of a gearwheel and left and right gear racks of the sound bar when the sound bar is positioned near an expanded state; and

FIG. 7 is a front elevational view of the sound bar with a partial skeleton view illustrating an arrangement of the gearwheel and the left and right gear racks of the sound bar when sound bar is positioned near a shortened state.

### DETAILED DESCRIPTION OF EMBODIMENTS

A preferred embodiment will now be explained with reference to the drawings. It will be apparent to those skilled in the art from these disclosures that the following descriptions of the preferred embodiment are provided for illustration only and not for the purpose of limiting the invention as defined by the appended claims and their equivalents.

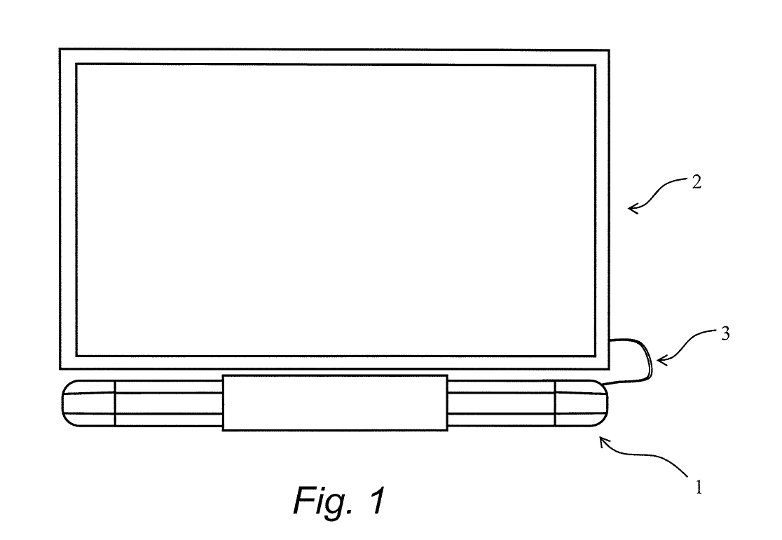

Referring to FIGS. 1-7, an extendable sound bar 1 will now be described in detail. As illustrated FIG. 1, the sound bar 1 is disposed below a flat panel TV 2. The sound bar 1 can also be disposed above the TV 2, or hanged on a wall when the TV 2 is hanged on the wall. The sound bar 1 is electrically connected to the TV 2 with a cable 3, such as a speaker cable, HDMI cable and so forth. The sound bar 1 outputs surround sound corresponding to video that is displayed on the TV 2. The surround bar 1 can also be used with an optional subwoofer (not shown) that is also connected to the TV 2. The sound bar 1 is much wider than it is tall. The length of the sound bar 1 is adjustable in a lengthwise direction L of the sound bar 1. Specifically, the sound bar 1 is adjustable between a shortened state and an expanded state. In the shortened state, the sound bar 1 has the shortest length of the sound bar 1. In the expanded state, the sound bar 1 has the longest length that is longer than the shortest length.

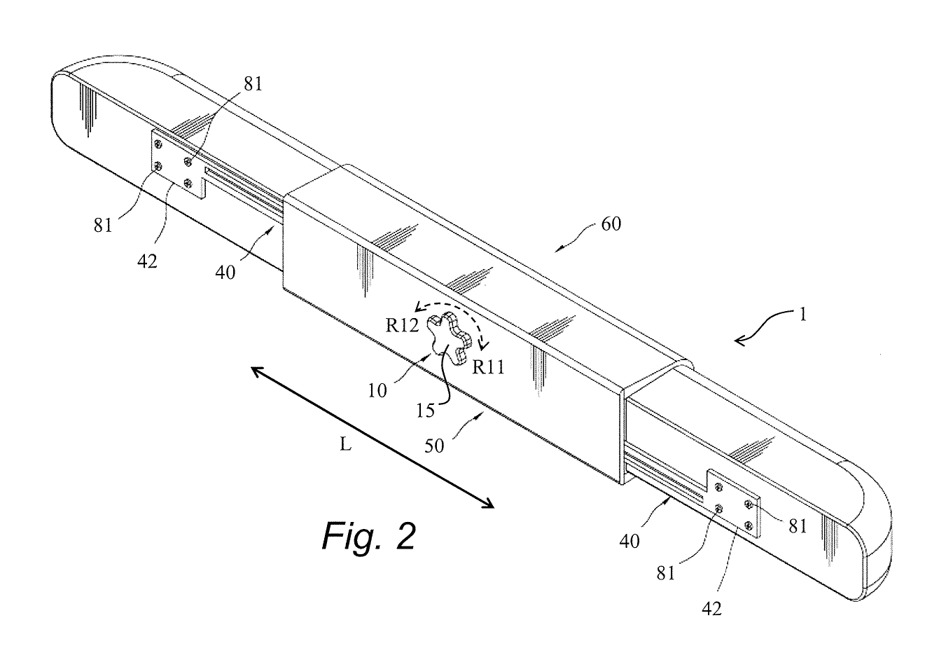

As illustrated in FIGS. 2-5, the sound bar 1 includes a rotary knob (e.g., rotary member) 10, a gearwheel (e.g., gearwheel member) 20, a plurality of rollers 31, a plurality of screw members 32, left and right gear racks (e.g., first and second rack members) 40, a rear cover 50, a front cover 60, and left and right sound boxes (e.g., first and second speaker boxes) 80. The gearwheel 20 and the left and right gear racks 40 form a gear mechanism of the sound bar 1. The rear cover 50 and the front cover 60 form a housing of the sound bar 1.

The rotary knob 10 is fixedly coupled to the gearwheel 20. The rotary knob 10 and the gearwheel 20 are rotatably attached to the rear cover 50 such that the rotary knob 10 and the gearwheel 20 sandwich the rear cover 50 therebetween. The rotary knob 10 and the gearwheel 20 integrally rotate together relative to the rear cover 50.

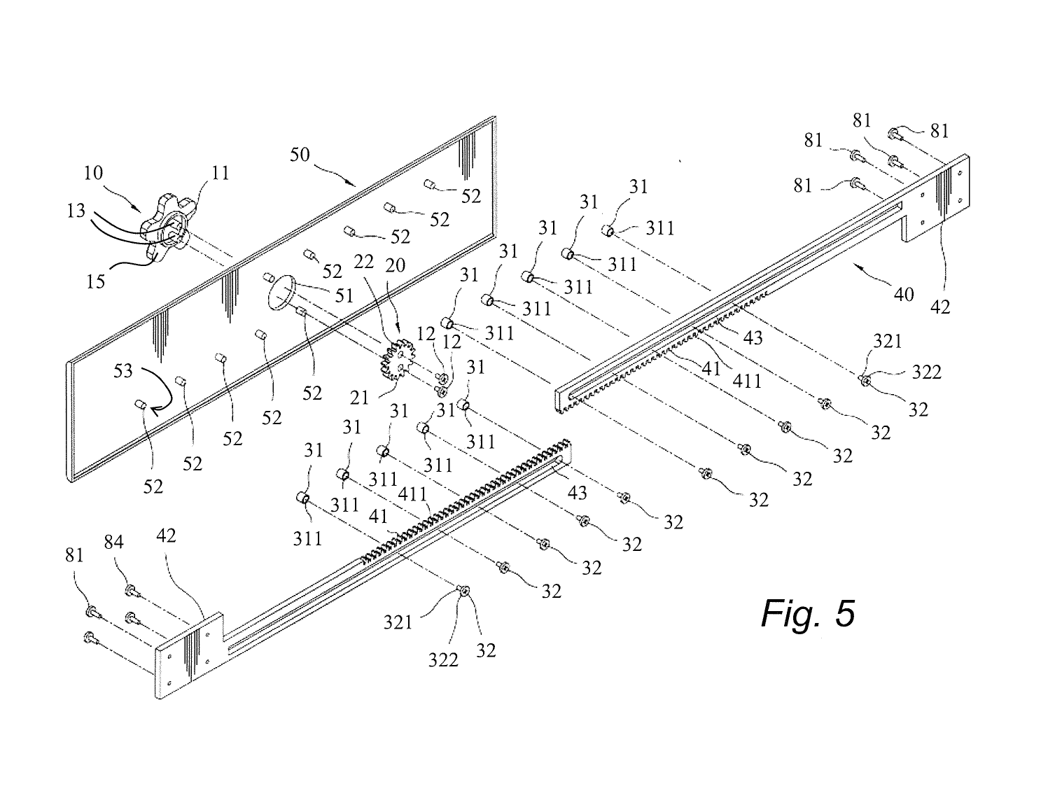

Specifically, as illustrated in FIG. 5, the rotary knob 10 mainly includes a bearing portion 11, a pair of fixing pins 13 and a head portion 15. The rear cover 50 mainly includes a bearing hole 51, and upper and lower sets of a plurality of (five in FIG. 5) protruding pins 52.

The rotary knob 10 is made of resin material, and is integrally formed as a one-piece, unitary member. The head portion 15 of the rotary knob 10 is disposed on a rear face of the rear cover 50. In other words, the head portion 15 is disposed outside of the housing formed by the rear cover 50 and the front cover 60. The bearing portion 11 and the fixing pins 13 extend from the head portion toward inside of the housing. The bearing portion 11 has a outer cylindrical face extending forward of the head portion 15 of the rotary knob 10 relative to a front face of the head portion 15 of the rotary knob 10. The outer cylindrical face of the bearing portion 11 is rotatably fitted to an inner face (e.g., inner cylindrical face) of the bearing hole 51 of the rear cover 50. In other words, the bearing portion 11 of the rotary knob 10 and the bearing hole 51 of the rear cover 50 form a plane bearing or a friction bearing. The plane bearing is a type of bearing having just a bearing surface and no rolling elements. The outer cylindrical face of the bearing portion 11 slides over the inner face of the bearing hole 51 in response to the rotary knob 10 being rotated by the user of the sound bar 1. The height of the bearing portion 11 relative to the front face of the head portion 15 of the rotary knob 10 in a direction parallel to an rotation center axis of the rotary knob 10 is at least equal to the height of the bearing hole 51 of the rear cover 50 (i.e., thickness of the rear cover 50). Thus, when the rotary knob 10 is attached to the rear cover 50, the distal end portion of the bearing portion 11 is aligned in plane with a front face of the rear cover 50 or located forward relative to the front face of the rear cover 50. The gearwheel 20 is mounted on an axial cylindrical end face of the distal end portion of the bearing portion 11. The fixing pins 13 are formed on a center portion of the front face of the rotary knob 10 radially inward of the bearing portion 11. The fixing pins 13 extend from the head portion 15 toward inside of the housing formed by the rear cover 50 and the front cover 60. The end portions of the fixing pins 13 are positioned inside of the housing. The end portions of the fixing pins 13 are inserted into fixing holes of the gearwheel 20, respectively. The fixing pins 13 have also threaded holes, respectively. The rotary knob 10 is fixedly coupled to the gearwheel 20 with fastening elements 12, such as screws. The fastening elements 12 are threaded into the threaded holes of the fixing pins 13, respectively, and fixedly couple the gearwheel 20 to the rotary knob 10.

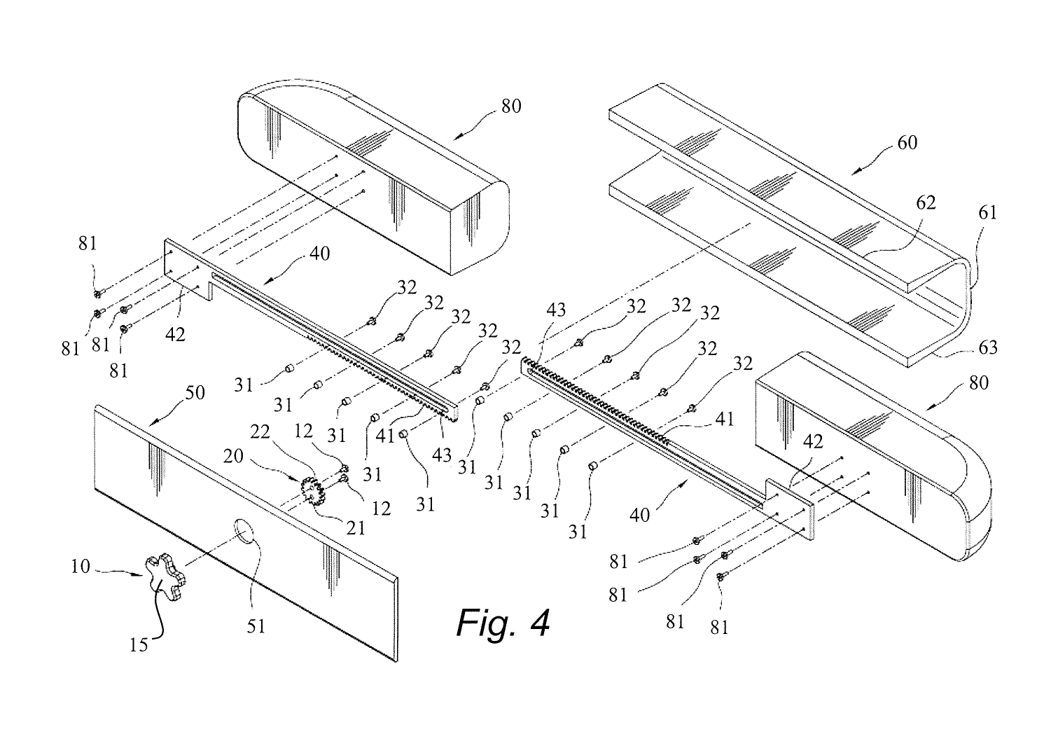

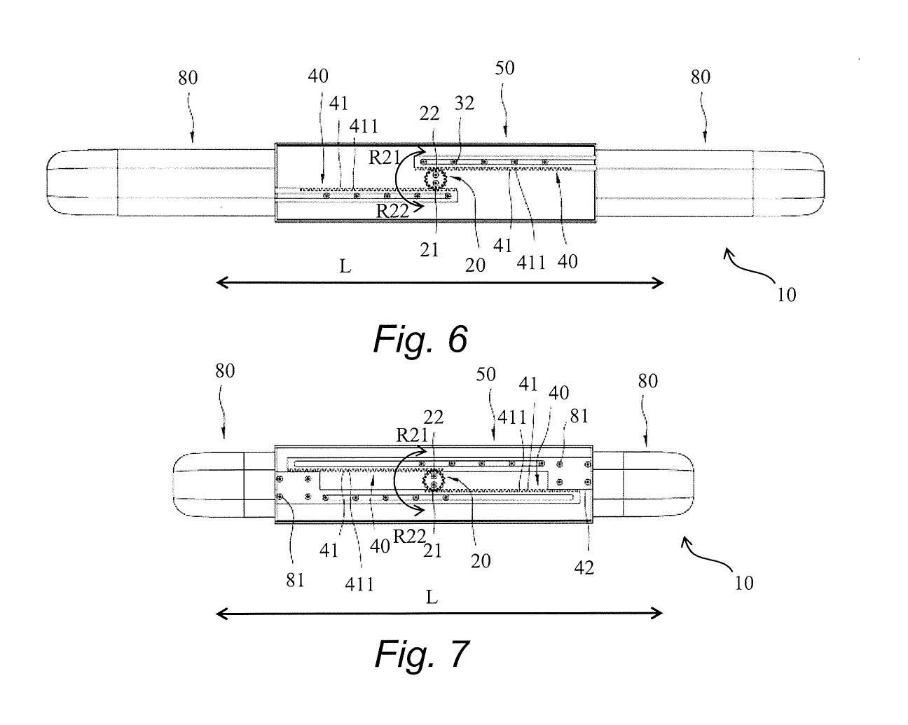

As illustrated in FIGS. 4 and 5, the gearwheel 20 has a plurality of teeth. The teeth are formed on an outer periphery of the gearwheel 20. As illustrated in FIGS. 6 and 7, the teeth of the gearwheel 20 mesh with both the left and right gear racks 40. In other words, the left and right gear racks 40 share the gearwheel 20, and form a pair of rack and pinion mechanisms (e.g., gear mechanism). The rotational movement of the gearwheel 20 is converted into linear movements (or sliding movement) of the left and right gear racks 40.

As illustrated in FIG. 5, the rear cover 50 have the bearing hole 51, and upper and lower sets (e.g., first and second guide portions) of a plurality of (five in FIG. 5) protruding pins 52. The rear cover 50 is made of resin, and is integrally foamed as a one-piece, unitary member. The protruding pins 52 protrude forward of the rear cover 50 relative to a front face of the rear cover 50. The upper set of the protruding pins 52 are aligned in a line along an upper edge of the rear cover 50 at a right upper portion of the rear cover 50 as viewed from the front side of the rear cover 50. The lower set of the protruding pins 52 are aligned in a line along a lower edge of the rear cover 50 at a left lower portion of the rear cover 50 as viewed from the front side of the rear cover 50. The protruding pins 52 have screw holes 53, respectively.

As illustrated in FIGS. 4-7, the left and right gear racks 40 are slidably attached to the rear cover 50 via the rollers 31. Each of the left and right gear racks 40 has a toothed portion 41 with a plurality of teeth 411, a mounting portion 42, and a sliding slot 43. Each of the left and right gear racks 40 is made of resin, and is formed as a one-piece, unitary member. The left and right gear racks 40 are identically formed each other. The toothed portion 41 extends along the lengthwise direction of each of the left and right gear racks 40. Specifically, the toothed portions 41 of the left and right gear racks 40 are disposed in parallel to each other. The sliding slot 43 is arranged in a parallel manner relative to the toothed portion 41. The sliding slot 43 is formed on the toothed portion 41 along the toothed portion 41. The mounting portion 42 is formed on one end of the toothed portion 41 of each of the left and right gear racks 40. As illustrated in FIGS. 2-5, the mounting portions 42 of the left and right gear racks 40 are fixedly coupled to left and right sound boxes 80, respectively, with a plurality of fastening elements 81, such as screws. The teeth 411 of the toothed portions 41 of the left and right gear racks 40 are respectively meshed with lower and upper teeth 21 and 22 of the gearwheel 20. The left and right gear racks 40 are identically formed each other as described above. However, the left and right gear racks 40 are arranged on the rear cover 50 in a point symmetric manner relative to the rotational axis of the rotary knob 10 as viewed in a direction along the rotational axis of the rotary knob 10. In other words, the right gear rack 40, which is disposed on the right hand side of the sound bar 1 as viewed from the front side, is arranged such that the teeth 411 is disposed downward of the right gear rack 40 relative to the toothed portion 41 of the right gear rack 40, and such that the teeth 411 direct downward, respectively, and mesh with the gearwheel 20 from above. On the other hand, the left gear rack 40, which is disposed on the left hand side of the sound bar 1 as viewed from the front side, is arranged such that the teeth 411 is disposed upward of the left gear rack 40 relative to the toothed portion 41 of the left gear rack 40, and such that the teeth 411 direct upward, respectively, and mesh with the gearwheel 20 from below. With this arrangement, as illustrated in FIGS. 6 and 7, the toothed portion 41 of the right gear rack 40 meshes with the upper teeth 22 of the gearwheel 20, and the toothed portion 41 of the left gear rack meshes with the lower teeth 21 of the gearwheel 20.

As illustrated in FIGS. 4 and 5, each of the rollers 31 has a cylindrical shape with an axle hole 311. The rollers 31 are rotatably attached to the protruding pins 52 of the rear cover 50, respectively, such that the protruding pins 52 are disposed through the axle holes 311, respectively. The rollers 31 attached to the protruding pins 52 are disposed inside of the sliding slots 43 of the left and right gear racks 40, respectively. Specifically, the rollers 31 attached to the upper set of the protruding pins 52 are disposed inside of the sliding slot 43 of the right gear rack 40, and guide the sliding movement of the right gear rack 40 in the lengthwise direction of the right gear rack 40 relative to the rear cover 50. On the other hand, the rollers 31 attached to the lower set of the protruding pins 52 are disposed inside of the sliding slot 43 of the left gear rack 40, and guide the sliding movement of the left gear rack 40 in the lengthwise direction of the left gear rack 40 relative to the rear cover 50. The axial lengths of the rollers 31 in an axial direction of the rollers 31 are at least equal to the thickness of the left and right gear racks 40.

The screw members 32 are fastened to the protruding pins 52, respectively. Specifically, each of the screw members 32 has a threaded shank 321 and an enlarged head 322. The threaded shanks 321 are inserted through the axle holes 311 and threaded to the screw holes 53 of the protruding pins 52, respectively. The enlarged heads 322 have a diameter larger than the outer diameter of the rollers 31. With this arrangement, when the left and right gear racks 40 are attached to the rear cover 50 via the rollers 31, the enlarged heads 322 engage with edge portions of the sliding slot 43 in a direction perpendicular to the front face of the rear cover 50. Thus, the movements of the left and right gear racks 40 in the direction perpendicular to the front face of the rear cover 50 are properly restricted.

As illustrated in FIGS. 2-4, the left and right sound boxes 80 are fixedly coupled to the mounting portions 42 of the left and right gear racks 40, respectively, with the respective fastening elements 81, such as screws. The left and right sound boxes 80 are disposed at opposite end portions of the housing formed by the rear cover 50 and the front cover 60 in the lengthwise direction of the sound bar 1. Each of the left and right sound boxes 80 includes one full-range speaker unit or a plurality of multi-way speaker units having speakers with different diameters. The left and right sound boxes 80 can include well-known speakers or speaker units used for the conventional sound bar. Thus, detailed descriptions of the well-known speakers or speaker units are omitted.

As illustrated in FIG. 4, the front cover 60 have a front wall 61 and opposing top and bottom walls 62 and 63. The top and bottom walls 62 and 63 extend rearward of the front cover 60 from top and bottom sides of the front wall 61, respectively. The front cover 60 is fixedly coupled to the rear cover 50 with fastening elements (not shown), such as screws, or by latching the front cover 60 to the rear cover 50.

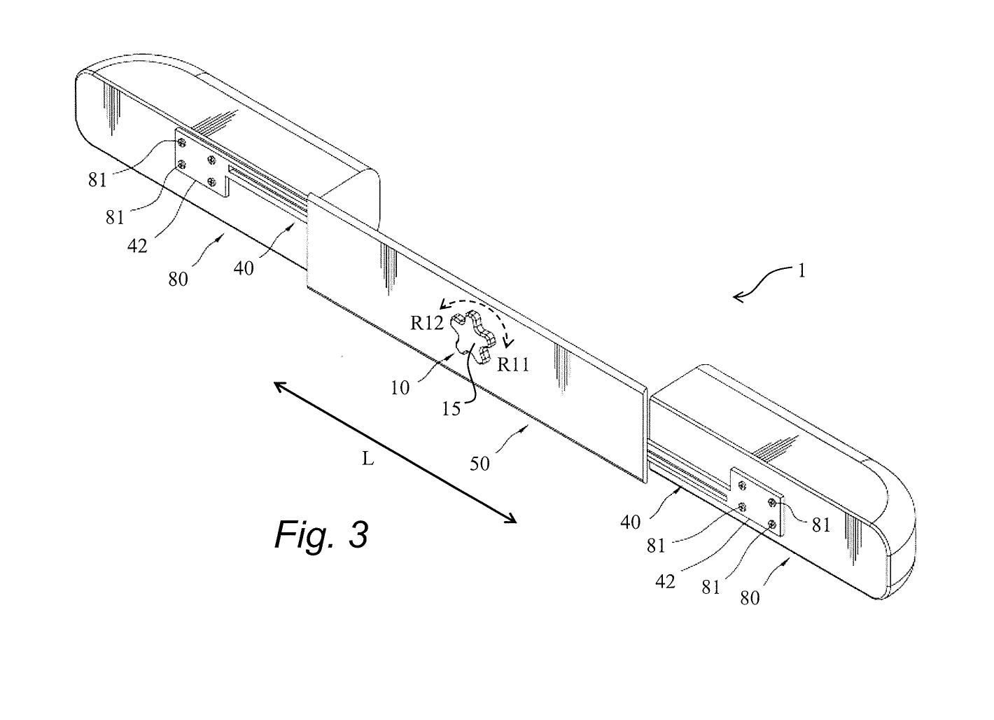

After the sound bar 1 is assembled, the rotary knob 10 is rotated manually to adjust the length of the sound bar 1 relative to the width of the TV 2 such that the length of the sound bar 1 acoustically and aesthetically fits the TV 2. Specifically, when the rotary knob 10 is rotated, the gear mechanism formed by the gearwheel 20 and the left and right gear racks 40 slide simultaneously both the left and right sound boxes 80 in opposite directions along the lengthwise direction of the sound bar 1. In particular, when the rotary knob 10 is rotated in a clockwise direction R11 as viewed from the rear side of the sound bar 1 as illustrated in FIGS. 2 and 3, the gearwheel 20 rotates in a counter-clockwise direction R22 as viewed from the front side of the sound bar 1 as illustrated in FIGS. 6 and 7. The rotational movement of the gearwheel 20 in the counter-clockwise direction R22 is converted into the linear movements of the left and right gear racks 40 toward each other. Specifically, the left and right gear racks 40 slides together with the left and right sound boxes 80 toward each other from the expanded state illustrated in FIG. 6 to the shortened state illustrated in FIG. 7, thereby shortening the distance between the left and right sound boxes 80. On the other hand, when the rotary knob 10 is rotated in a counter-clockwise direction R12 as viewed from the rear side of the sound bar 1 as illustrated in FIGS. 2 and 3, the gearwheel 20 rotates in a clockwise direction R21 as viewed from the front side of the sound bar 1 as illustrated in FIGS. 6 and 7. The rotational movement of the gearwheel 20 in the clockwise direction R21 is converted into the linear movements of the left and right gear racks 40 apart from each other. Specifically, the left and right gear racks 40 slides together with the left and right sound boxes 80 apart from each other from the shortened state illustrated in FIG. 7 to the expanded state illustrated in FIG. 6, thereby expanding the distance between the left and right sound boxes 80. Accordingly, with this sound bar 1, the distance between the left and right sound boxes 80 or the length of the sound bar 1 can easily be adjusted simply by rotating the rotary knob 10, and can be fitted different sizes of TV 2, such as TVs having a display sizes ranging from 32″-46″, for example.

With the sound bar 1, the left and right gear racks 40 mesh with the lower and upper teeth 21 and 22, respectively. However, the left and right gear racks 40 can be arranged such that the left and right gear racks 40 mesh with the upper and lower teeth 22 and 21, respectively. In this case, when the gearwheel 20 rotates in the counter-clockwise direction R22, the left and right gear racks 40 slides apart from each other from the shortened state to the expanded state, thereby expanding the distance between the left and right sound boxes 80. On the other hand, when the gearwheel 20 rotates in the clockwise direction R21, the left and right gear racks 40 slides toward each other from the expanded state to the shortened state, thereby shortening the distance between the left and right sound boxes 80.

### General Interpretation of Terms

In understanding the scope of the present invention, the term “comprising” and its derivatives, as used herein, are intended to be open ended terms that specify the presence of the stated features, elements, components and groups, but do not exclude the presence of other unstated features, elements, components and groups. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. As used herein to describe the present invention, the following directional terms “forward, rearward, above, downward, vertical, horizontal, below and transverse” as well as any other similar directional terms refer to those directions of a sound bar equipped with the present invention. Accordingly, these teens, as utilized to describe the present invention should be interpreted relative to a sound bar equipped with the present invention as used in the normal operating position.

While a preferred embodiment have been chosen to illustrate the present invention, it will be apparent to those skilled in the art from these disclosures that various changes and modifications can be made herein without departing from the scope of the invention as defined in the appended claims. Furthermore, the foregoing descriptions of the preferred embodiment according to the present invention are provided for illustration only, and not for the purpose of limiting the invention as defined by the appended claims and their equivalents.

What is claimed is:

1. A sound bar comprising:
a housing;
a rotary member rotatable with respect to the housing;
first and second speaker boxes slidable with respect to the housing, respectively, the first and second speaker boxes being disposed at opposite end portions of the housing in a lengthwise direction of the housing, respectively; and
a gear mechanism disposed between the rotary member and the first and second speaker boxes, the gear mechanism being configured to slide both the first and second speaker boxes with respect to the housing in opposite directions of the housing along the lengthwise direction of the housing in response to a rotational movement of the rotary member.

2. The sound bar according to claim 1, wherein
the gear mechanism includes a gearwheel member that is fixedly coupled to the rotary member, and first and second rack members that mesh with the gearwheel member, the first and second rack members being fixedly coupled to the first and second speaker boxes, respectively.

3. The sound bar according to claim 2, wherein
each of the first and second rack members has a mounting portion and a toothed portion that extends from the mounting portion, the mounting portions of the first and second rack members being fixedly coupled to the first and second speaker boxes, respectively, the toothed portions of the first and second rack members meshing with the gearwheel member.

4. The sound bar according to claim 3, wherein
the toothed portions of the first and second rack members are disposed in parallel to each other, the toothed portion of the first rack member meshing with the gearwheel member from above, the toothed portion of the second rack member meshing with the gearwheel member from below.

5. The sound bar according to claim 4, wherein
the housing has a rear cover with first and second guide portions; and
the toothed portions of the first and second rack members further have sliding slots, respectively, the sliding slots extending along the toothed portions of the first and second rack members, respectively, the sliding slots receiving the first and second guide portions of the rear cover, respectively, such that the first and second guide portions of the rear cover relatively slide along the sliding slots of the first and second rack members, respectively, in response to the rotational movement of the rotary member.

6. The sound bar according to claim 5, wherein
each of the first and second guide portions has a plurality of protruding pins, the protruding pins of the first and second guide portions extending forward of the sound bar with respect to a front face of the rear cover, the protruding pins of the first guide portion being aligned in the lengthwise direction of the housing, the protruding pins of the second guide portion being aligned in the lengthwise direction of the housing.

7. The sound bar according to claim 6, wherein
the protruding pins of the first and second guide portions are disposed through the sliding slots of the first and second rack members, respectively.

8. The sound bar according to claim 1, wherein
the housing has a rear cover with a bearing hole, the bearing hole having an inner cylindrical face, and
the rotary member has a head portion and a bearing portion with an outer cylindrical face, the head portion being disposed outside of the housing, the bearing portion extending from the head portion toward inside of the housing, the bearing portion being disposed through the bearing hole of the rear cover such that the outer cylindrical face of the bearing portion radially faces the inner cylindrical face of the bearing hole to form a plane bearing.

9. The sound bar according to claim 8, wherein
the outer cylindrical face of the bearing portion slides over the inner cylindrical face of the bearing hole in response to the rotational movement of the rotary member.

10. The sound bar according to claim 2, wherein
the housing has a rear cover with a bearing hole, the bearing hole having an inner cylindrical face, and
the rotary member has a head portion and a bearing portion with an outer cylindrical face, the head portion being disposed outside of the housing, the bearing portion extending from the head portion toward inside of the housing, the bearing portion being disposed through the bearing hole of the rear cover such that the outer cylindrical face of the bearing portion radially faces the inner cylindrical face of the bearing hole to form a plane bearing.

11. The sound bar according to claim 10, wherein
the outer cylindrical face of the bearing portion slides over the inner cylindrical face of the bearing hole in response to the rotational movement of the rotary member.

12. The sound bar according to claim 10, wherein
the rotary member further has a fixing portion that extends from the head portion toward inside of the housing, an end portion of the fixing portion being positioned inside of the housing, and
the gearwheel member of the gear mechanism is positioned inside of the housing, the gearwheel member of the gear mechanism being fixedly coupled to the end portion of the fixing portion.
